(19) United States
(12) Patent Application Publication
(10) Pub. No.: US 2007/0125606 A1
(43) Pub. Date: Jun. 7, 2007

(54) Adjusting device for positioning brake lining relative to a brake disk of a bicycle

(76) Inventor: Jui-Pin Chen, Changhua City (TW)

Correspondence Address: Frenkel & Associates, P.C., Suite 330, 3975 University Drive, Fairfax, VA, 22030, US

(21) Appl. No.: 11/296,090

(22) Filed: Dec. 7, 2005

(51) Int. Cl. B62L 1/06

(52) U.S. Cl. 188/24.19; 188/17

(57) ABSTRACT

A adjusting device includes arms extending out of the brake assembly and each arm having an abutting surface formed on a free end of the arm and a threaded hole defined in the abutting surface. Threaded bolts each has a spherical head and a threaded rod extending out of the spherical head to be threadingly inserted into a corresponding one of the threaded holes of the arms after passing through a corresponding one of the holes of the connector. A connector is adapted to be formed on an outer periphery of the bicycle frame and having holes so configured that after the spherical head of each of the threaded bolts and the abutting surface of the arms are respectively and oppositely received in the holes, position of the brake assembly is adjustable before firmly connecting the brake assembly to the bicycle frame via the threaded bolts.

### BACKGROUND OF THE INVENTION

1. Field of the Invention

The present invention relates to an adjusting device, and more particularly to an adjusting device for positioning brake linings of a bicycle so that the brake linings are able to be properly applied to the brake disk.

2. Description of the Prior Art

In order to have a good brake effect for bicycles, the conventional brake drum is replaced with a brake disk, such that the brake linings are able to be applied onto the brake disk surface.

Before mounting the brake linings onto the bicycle frame, the brake disk has already been mounted on the bicycle frame. Therefore, it is necessary to precisely mount the brake linings on the bicycle frame so that the brake linings are able to be properly applied onto the brake disk surface. In order to adjust the position of the brake linings relative to the brake disk, U.S. Pat. No. 6,230,849 and U.S. Pat. 6,431,327 provide different adjusting devices to align the brake linings with the brake disk. However, due to the structural limitations and the large quantity of parts involved, both adjusting devices are not able to provide satisfactory brake effect without increasing the cost.

To overcome the shortcomings, the present invention tends to provide an improved adjusting device to mitigate the aforementioned problems.

### SUMMARY OF THE INVENTION

The primary objective of the present invention is to provide an adjusting device for easily aligning with the brake disk so as to allow the brake linings to be applied onto the brake disk surface properly.

In order to accomplish the objective, it is noted that the adjusting device of the present invention includes a pair of connection arms adapted to extend out from a brake assembly, a pair of through holes adapted to be defined in a connector which is formed on a side face of the bicycle frame, a pair of cushion pads sandwiched between the brake assembly and the connector and a pair of adjusting pads sandwiched between the connector and a pair of threaded bolts each having a spherical head formed on a free end thereof. Each of the adjusting pads and the cushion pads is provided with an arcuate surface to correspond to the spherical head of the threaded bolt and a spherical abutting head formed on a free end of each of the arms. Therefore, after the two threaded bolts are threadingly extended into the brake assembly, the mating among the spherical head, the spherical abutting head and the arcuate surface allows the user to easily adjust the position of the brake assembly relative to the brake disk.

Other objects, advantages and novel features of the invention will become more apparent from the following detailed description when taken in conjunction with the accompanying drawings.

### BRIEF DESCRIPTION OF THE DRAWINGS

FIG. 1 is an exploded perspective view showing parts of the present invention in combination with the brake assembly and the brake disk;

FIG. 2 is a perspective view showing that the adjusting device of the present invention is assembled onto the bicycle frame;

FIG. 3 is a schematic cross sectional view showing the mutual relationship between the pads and the threaded bolt of the adjusting device of the present invention;

FIG. 4 is an schematic operational cross sectional view showing that the threaded bolt is able to move relative to the pads and the bicycle frame;

FIG. 5 is a schematic cross sectional view showing a second embodiment of the present invention;

FIG. 6 is a schematic cross sectional view showing a third embodiment of the present invention;

FIG. 7 is a schematic cross sectional view showing a fourth embodiment of the present invention; and

FIG. 8 is a schematic cross sectional view showing a fifth embodiment of the present invention.

### DETAILED DESCRIPTION OF THE PREFERRED EMBODIMENT

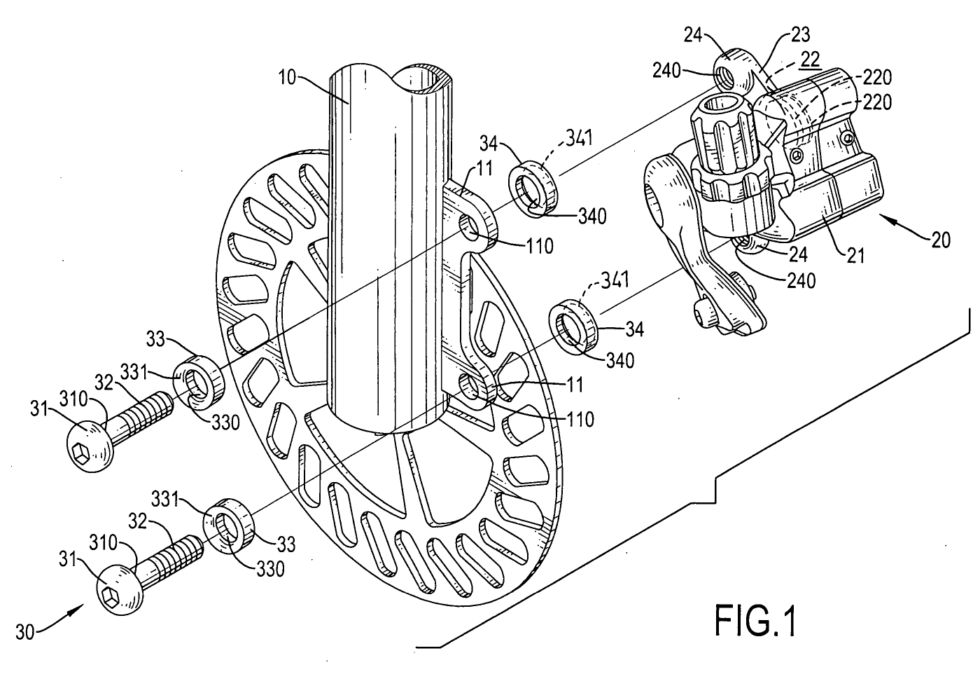

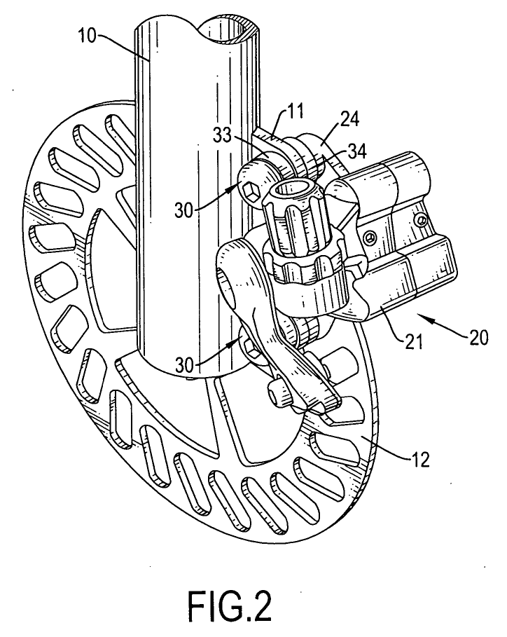

With reference to FIGS. 1 and 2, it is noted that the adjusting device (30) in accordance with the present invention includes is applied to a bicycle frame (10) and a brake assembly (20) to be mounted onto the bicycle frame (10).

The bicycle frame (10) includes a connector (11) adapted to be integrally formed on an outer surface of the bicycle frame (10) and having holes (110) oppositely defined in the connector (11) and a brake disk (12) securely formed on the bicycle frame (10) and provided on a side of the connector (11). The brake assembly (20) includes a body (21), a gap (22) defined in the body (21) to receive therein brake linings (220), two arms (23) oppositely extending out of the body (21) and each arm (23) having a spherical abutting face (24) formed on a free end of the arm (24) and a threaded hole (240) defined through the spherical abutting face (24). An axis extending from either one of the holes (110) is parallel to a direction where the brake lining (220) is allowed to be moved.

The adjusting device (30) includes two threaded bolts (31) each provided with a spherical head (310) and a threaded rod (32) extending from the spherical head (310). A pair of adjusting pads (33) is sandwiched between the connector (11) and the pair of threaded bolts (31) and a pair of cushion pads (34) is sandwiched between the connector (11) and the pair of arms (23) of the brake assembly (20). Each adjusting pad (33) is provided with a through hole (330) to allow an extension of a corresponding one of the two threaded bolts (31) and a first arcuate surface (331) defined in a periphery defining the through hole to correspond to the spherical head (310) of the threaded bolt (31). Each cushion pad (34) is provided with a through hole (340) to allow an extension of a corresponding one of the two threaded bolts (31) and a second arcuate surface (341) defined in a periphery defining the through hole to correspond to the spherical abutting face (24) of the arm (23).

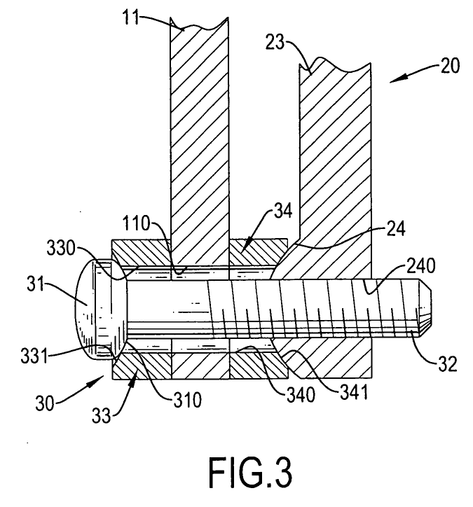

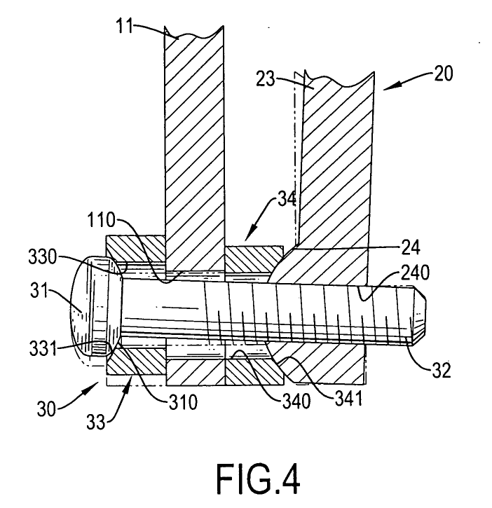

With reference to FIG. 3 and still using FIG. 2 for reference, it is noted that when the adjusting device of the present invention is applied to connect the brake assembly (20) to the bicycle frame (10), each of the two threaded bolts (31) is extended through a corresponding one of the through holes (330) of the adjusting pads (34), a corresponding one of the two holes (11) of the connector (11), a corresponding one of the through holes (340) of the two cushion pads (34) and into a corresponding one of the two threaded holes (240) of the arms (23). Before securing the threaded bolt (31) into the corresponding threaded hole (240) of he arm (23), the spherical head (310) is mated with the first arcuate surface (331) of the adjusting pad (33) and the spherical abutting surface (24) is mated with the second arcuate surface (341) of the cushion pad (34). Also, because the diameter of the through holes (330,340) of both the adjusting pad (33) and the cushion pad (34) is larger than that of the threaded bolt (31), the threaded bolt (31) is able to be moved relative to the adjusting pad (33) as well as the cushion pad (34). That is, if the brake assembly (20) is not positioned properly relative to the brake disk (12) on the bicycle frame (10), the operator is able to move around the brake assembly (20), as shown in FIG. 4, to align the brake assembly (20) with the brake disk (as shown in FIG. 1) via the mating relationship between the spherical abutting surface (24) and the second arcuate surface (341) and the relationship between the spherical head (310) and the first arcuate surface (331). Then after the brake assembly (20) is aligned with the brake disk (12), the operator is able to extend the threaded bolts (31) further into the threaded holes (230) of the arms (23) to firmly secure the relative position between the brake assembly (20) and the brake disk (12).

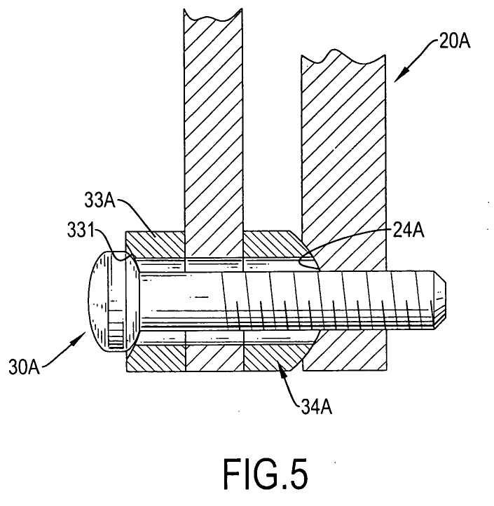

With reference to FIG. 5, it is noted that first arcuate surface of the adjusting pad (33A) is a concave surface (331) and the second arcuate surface of the cushion pad (34A) is a convex surface to correspond to a concave opening defined in the threaded hole (240) of the spherical abutting surface (24A).

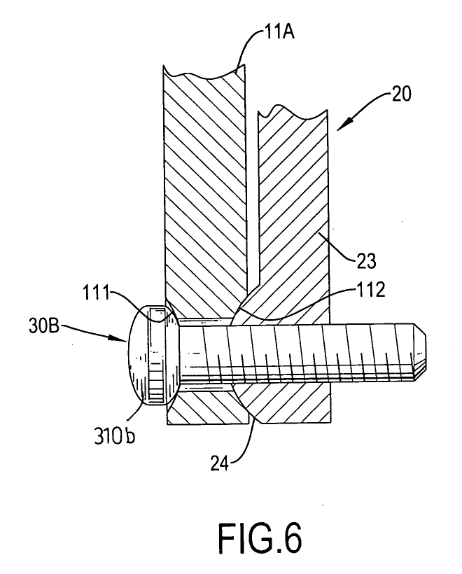

With reference to FIG. 6, it is noted that no pad is applied either between the threaded bolt (31B) of the adjusting device (30B) and the connector (11A) or between the connector (11A) and the arm (23) of the brake assembly (20). As can be depicted from the drawing that the arm (23) has a convex surface (24) and the connector (11A) has a complementary concave surface (111,112) respectively defined in opposite side face of the connector (11A) to correspond to the spherical head (310B) and the convex surface (24) of the arm (23) of the brake assembly (20).

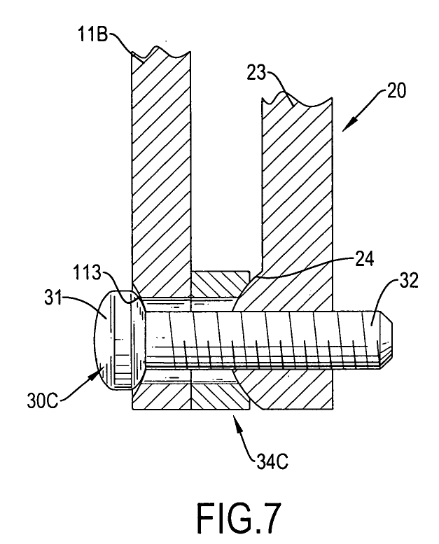

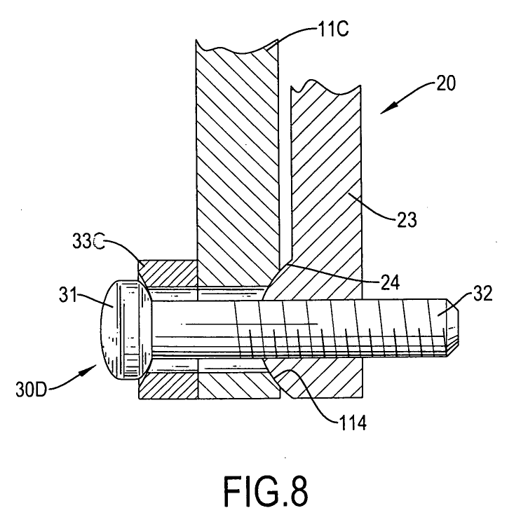

With reference to FIGS. 7 and 8, it is noted that only one pad is applied between the brake assembly (20) and the connector (11B) of the adjusting device (30C), i.e. the cushion pad (34C) or between the threaded bolt (31) and the connector (11C), i.e. the adjusting pad (33C).

It is to be understood, however, that even though numerous characteristics and advantages of the present invention have been set forth in the foregoing description, together with details of the structure and function of the invention, the disclosure is illustrative only, and changes may be made in detail, especially in matters of shape, size, and arrangement of parts within the principles of the invention to the full extent indicated by the broad general meaning of the terms in which the appended claims are expressed.

What is claimed is:

1. An adjusting device applied to a bicycle frame which has a brake disk affixed to a side of the bicycle frame and a brake assembly which is mounted on the bicycle frame such that brake linings inside the brake assembly are able to be applied to the brake disk, wherein the adjusting device comprises:
arms adapted to be oppositely extending out of the brake assembly and each arm having an abutting surface formed on a free end of the arm and a threaded hole defined in the abutting surface;
threaded bolts each having a spherical head and a threaded rod extending out of the spherical head to be threadingly inserted into a corresponding one of the threaded holes of the arms after passing through a corresponding one of the holes of the connector;
a connector adapted to be formed on an outer periphery of the bicycle frame and having holes so configured that after the spherical head of each of the threaded bolts and the abutting surface of the arms are respectively and oppositely received in the holes, position of the brake assembly is adjustable before firmly connecting the brake assembly to the bicycle frame via the threaded bolts.

2. The adjusting device as claimed in claim 1, wherein the abutting surface of the arm is a spherical abutting face and the connector has a concave surface defined in a periphery defining the hole so that the spherical abutting surface is snugly received in the hole.

3. The adjusting device as claimed in claim 1 further comprising a pair of adjusting pads sandwiched between the threaded bolts and the connector, wherein each adjusting pad is composed of a first through hole defined to allow an extension of a corresponding one of the threaded rods of the threaded bolts and a first arcuate surface defined in a periphery defining the first through hole to correspond to the spherical head of a corresponding one of the threaded bolts such that after the threaded bolts are extended through the first through holes, complementary relationship between the spherical head and the first arcuate surface of the adjusting pad allows the threaded bolts to be moved relative to the adjusting pad.

4. The adjusting device as claimed in claim 2 further comprising a pair of adjusting pads sandwiched between the threaded bolts and the connector, wherein each adjusting pad is composed of a first through hole defined to allow an extension of a corresponding one of the threaded rods of the threaded bolts and a first arcuate surface defined in a periphery defining the first through hole to correspond to the spherical head of a corresponding one of the threaded bolts such that after the threaded bolts are extended through the first through holes, complementary relationship between the spherical head and the first arcuate surface of the adjusting pad allows the threaded bolts to be moved relative to the adjusting pad.

5. The adjusting device as claimed in claim 1 further comprising a pair of cushion pads sandwiched between the connector and the brake assembly, wherein each cushion pad is composed of a second through hole defined to allow an extension of a corresponding one of the threaded rods of the threaded bolts and a second arcuate surface defined in a periphery defining the second through hole to correspond to the abutting surface of the arm such that after the threaded bolts are extended through the second through holes, complementary relationship between the second arcuate surface of the cushion pad and the abutting surface of the arm allows the brake assembly to be adjusted relative to the connector as well as the brake disk.

6. The adjusting device as claimed in claim 2 further comprising a pair of cushion pads sandwiched between the connector and the brake assembly, wherein each cushion pad is composed of a second through hole defined to allow an extension of a corresponding one of the threaded rods of the threaded bolts and a second arcuate surface defined in a periphery defining the second through hole to correspond to the spherical abutting surface of the arm such that after the threaded bolts are extended through the second through holes, complementary relationship between the second arcuate surface of the cushion pad and the abutting surface of the arm allows the brake assembly to be adjusted relative to the connector as well as the brake disk.

7. The adjusting device as claimed in claim 3 further comprising a pair of cushion pads sandwiched between the connector and the brake assembly, wherein each cushion pad is composed of a second through hole defined to allow an extension of a corresponding one of the threaded rods of the threaded bolts and a second arcuate surface defined in a periphery defining the second through hole to correspond to the spherical abutting surface of the arm such that after the threaded bolts are extended through the second through holes, complementary relationship between the second arcuate surface of the cushion pad and the abutting surface of the arm allows the brake assembly to be adjusted relative to the connector as well as the brake disk.

8. The adjusting device as claimed in claim 4 further comprising a pair of cushion pads sandwiched between the connector and the brake assembly, wherein each cushion pad is composed of a second through hole defined to allow an extension of a corresponding one of the threaded rods of the threaded bolts and a second arcuate surface defined in a periphery defining the second through hole to correspond to the spherical abutting surface of the arm such that after the threaded bolts are extended through the second through holes, complementary relationship between the second arcuate surface of the cushion pad and the abutting surface of the arm allows the brake assembly to be adjusted relative to the connector as well as the brake disk.

9. The adjusting device as claimed in claim 1, wherein the arm has a concave abutting surface and the connector has a convex surface to be received in the concave abutting surface such that after the threaded bolts are extended through the connectors and into the arms, the brake assembly is allowed to be adjusted.

10. The adjusting device as claimed in claim 5, wherein an axis extending from each of the holes is horizontal to a direction where the brake linings are moved.

11. The adjusting device as claimed in claim 6, wherein an axis extending from each of the holes is horizontal to a direction where the brake linings are moved.

12. The adjusting device as claimed in claim 7, wherein an axis extending from each of the holes is horizontal to a direction where the brake linings are moved.

13. The adjusting device as claimed in claim 8, wherein an axis extending from each of the holes is horizontal to a direction where the brake linings are moved.

14. The adjusting device as claimed in claim 9, wherein an axis extending from each of the holes is horizontal to a direction where the brake linings are moved.

15. The adjusting device as claimed in claim 5, wherein an axis extending from each of the holes is vertical to a direction where the brake linings are moved.

16. The adjusting device as claimed in claim 6, wherein an axis extending from each of the holes is vertical to a direction where the brake linings are moved.

17. The adjusting device as claimed in claim 7, wherein an axis extending from each of the holes is vertical to a direction where the brake linings are moved.

18. The adjusting device as claimed in claim 8, wherein an axis extending from each of the holes is vertical to a direction where the brake linings are moved.

19. The adjusting device as claimed in claim 9, wherein an axis extending from each of the holes is vertical to a direction where the brake linings are moved.
